(19) United States
(12) Patent Application Publication
(10) Pub. No.: US 2023/0288340 A1
(43) Pub. Date: Sep. 14, 2023

(54) REAL-TIME RAMAN CALIBRATION

(71) Applicant: Harry Owen, Frankiln, MI (US)

(72) Inventor: Harry Owen, Frankiln, MI (US)

(21) Appl. No.: 17/386,723

(22) Filed: Jul. 28, 2021

Related U.S. Application Data
(60) Provisional application No. 63/058,714, filed on Jul. 30, 2020.

(51) Int. Cl. G01N 21/65

(52) U.S. Cl. CPC G01N 21/65; G01N 2201/127; G01N 2201/06113

(57) ABSTRACT

A Raman calibration standard incorporated within an optical Raman sampling accessory facilitates wavelength calibration in real time. The accessory may be a microscope objective, immersion probe, non-contact probe optic or flow cell utilizing laser light from the UV to the NIR, and the calibration standard material may comprise calcium fluoride, sapphire, diamond, magnesium fluoride or silicon. The calibration standard material may be disposed in a collimated light space within the accessory, and/or may function as a lens, sealed window, reflector or a combination thereof. A plurality of calibration standard materials may be incorporated into the accessory and used for independent calibration verification. The accessory may include a single lens or an achromatic focusing lens. The system may further include features to improve curve fitting and generate a more precise wavenumber value for the position of a reference Raman band generated by the calibration standard material.

### REFERENCE TO RELATED APPLICATIONS

This application claims priority to, and the benefit of, U.S. Provisional Patent Application Ser. No. 63/058,714, filed Jul. 30, 2020, the entire content of which is incorporated herein by reference.

### FIELD OF THE INVENTION

This invention relates generally to Raman spectroscopy and, in particular, to Raman analysis systems wherein a calibration standard material is incorporated into a sample collection path facilitating wavelength calibration in real time.

### BACKGROUND OF THE INVENTION

Techniques such as Raman spectroscopy use a beam of light to identify and measure the molecular constituents of a sample. Raman, for example, relies on inelastic scattering of monochromatic light, usually from a laser in the visible, near infrared, or near ultraviolet range.

The traditional wavelength calibration protocol for a Raman instrument requires that wavelength variation of the laser and spectrograph be regularly checked to ensure that the instrument is operating correctly and consistently, and is adjusted as required to meet the required performance specifications.

Laser wavelength and wavenumber precision is critical for quantitative Raman measurements. Currently recommended wavelength calibration procedures measure directly, and use known or accepted spectral positions of the Raman bands within chemical standards such as cyclohexane or polystyrene^{1,2}, or use the known spectral positions of neon lines³ from a stable light source.

The currently recommended intensity calibration procedures to determine the intensity response of the spectrograph use a NIST Traceable White Light³ or NIST Fluorescent Glass⁴. For quantitative Raman measurements the accuracy of the measurement relies on the correlation of primary method measurements (e.g., GC, HPLC by weight), with Raman spectra acquired from similar samples.

The currently recommended wavelength calibration procedures address only the instrument, and assume that the instrument is operating consistently between calibration measurements.

Real-time instrument calibration may be advantageous. Solutions have been proposed and patented by Eastman Chemical⁵ and Bruker Optical⁶ that address the calibration issues associated with the instrument, but do not address the wavelength calibration issues associated with the optically filtered probe head or sample. The Eastman Chemical approach is to simultaneously irradiate a reference material and a chemical composition containing one or more constituents, simultaneously collecting Raman spectra of the reference material and the chemical composition. A convolution function is then applied to adjust the Raman spectrum of the chemical sample.

The Bruker Optical approach is to collect the spectra of sample and integrated neon light source spectra on different areas of the same CCD detector. By using these two “channels,” the data sets can be combined to adjust for “breathing effects” of the spectrometer. Using an integral transform process, the Raman data is corrected for instrument instabilities and therefore yields a Raman spectrum, that is automatically calibrated in frequency.

Changes in wavenumber precision that are generated by the optically filtered probe head and by the sample are not generally included in the recommended calibration procedures. Temperature changes within the sample will cause the Raman bands to change in wavenumber position, band height and bandwidth as reported in the literature.⁷

It is also well known that temperature has an influence on instrument accuracy in spectroscopy. Changes in room temperature and associated changes in wavenumber value between calibration measurements are not generally addressed as a wavenumber variance in Raman microscopy. Calibration shifts of 0.2-0.3 cm−1 per degree of room temperature have been reported for a research grade Raman microscope. A larger calibration shift of approximately 1.6 cm−1 per degree of temperature change has also been reported⁸.

Given the deficiencies in current wavelength calibration techniques, the need remains for a more accurate and repeatable solution.

### SUMMARY OF THE INVENTION

This invention is directed to the integration of a Raman calibration standard within an optical Raman sampling accessory. The configuration is used to simultaneously generate a Raman spectral reference band superimposed onto the sample spectra to facilitate wavelength calibration, including wavelength calibration in real time. The sampling accessory may include, without limitation, a Raman microscope, Raman immersion probe, Raman probe optic or Raman flow cell utilizing laser light from the UV to the NIR region of the electromagnetic spectrum.

In accordance with the invention, unwanted wavenumber shifts observed in the Raman spectra due to laser instability, thermal drifting of the spectrograph or spectral differences in different optically filtered probe heads can be corrected for in real time by recentering the measured Raman spectra to the assigned wavenumber value of the Raman spectral band from the calibration standard superimposed onto the Raman spectra of the sample.

Unwanted wavenumber shifts observed in the Raman spectra from changes in the sample temperature can also be corrected for in real time by recentering the measured Raman spectra to the assigned wavenumber value of the Raman spectral band from the calibration standard. In addition, changes in sample pressure can be measured in real time by tracking the difference between the measured Raman spectra from the sample to the measured spectral band from the calibration standard.

A Raman analysis system with integrated wavelength calibration comprises a sampling accessory used to deliver a collection beam from a laser-excited sample to a spectrograph for determining the Raman spectrum of the sample. At least one calibration standard material is incorporated into the sampling accessory, such that the spectrograph simultaneously receives a Raman spectrum of the sample and a Raman spectrum of the calibration standard, and wherein the Raman spectrum of the calibration standard is used to calibrate the Raman spectrum of the sample. In particular, the Raman spectrum of the sample may be recentered to the assigned wavenumber value associated with the Raman Calibration Standard material(s). In preferred embodiments, the Raman spectrum of the calibration standard is used to calibrate the Raman spectrum of the sample in real time.

The sampling accessory may be a Raman microscope objective, immersion probe, non-contact probe optic or flow cell, and the calibration standard material may comprise calcium fluoride, sapphire, diamond, magnesium fluoride or silicon.

The calibration standard material may be disposed in a collimated light space within the accessory, and/or may function as a lens, sealed window, reflector or a combination thereof. A plurality of calibration standard materials may be incorporated into the accessory and used for independent calibration verification. The accessory may include a single lens or an achromatic focusing lens.

The system may further include a fiber bundle for Raman signal collection to improve curve fitting and generate a more precise wavenumber value for the position of a reference Raman band generated by the calibration standard material. As a further option, the system may include an achromatic cylindrical lens images a line from a larger diameter fiber optic onto an entrance slit of a spectrograph to improve curve fitting and generate a more precise wavenumber value for the position of a reference Raman band generated by the calibration standard material.

In all embodiments, the precise and repeatable wavenumber value for the position of a Raman reference band generated by the Raman calibration standard facilitates calibration correction and transfer between different instruments and probes at different locations. The improved wavenumber precision improve the qualitative performance of material identification using Raman libraries. Wavenumber shifts of greater than 0.1 wavenumbers will have a negative impact on chemical concentration predictions when using a chemometric model. Raman spectra recentered to the assigned wavenumber value associated with the Raman Calibration Standard will lead to improved measurement sensitivity and calibration transfer between different probes and instruments, allowing for global deployment, while reducing the need to modify or create new calibration models generating significant cost savings.

### BRIEF DESCRIPTION OF THE DRAWINGS

FIG. 1 depicts the Raman spectra of selected grade of CaF2 shows a baseline separated Raman band at 321.0 wavenumbers;

FIG. 2 shows the Raman spectra of a pharma tablet containing acetaminophen, aspirin and caffeine with the 321.0 wavenumber band from a selected grade of calcium fluoride superimposed onto the Raman spectra of the pharma tablet;

FIG. 3A shows the use of a calibration standard acting as combined CaF₂/sapphire window at the distal end of the probe head;

FIG. 3B shows the use of a sapphire window in conjunction with a combined CaF₂ window and retroreflector;

FIG. 3C illustrates the use of a CaF2 window or combined CaF2/sapphire window and retroreflector;

FIG. 4A illustrates the use of a single lens optic with a calibration standard lens or window;

FIG. 4B depicts the use of a calibration standard lens acting as a sealed window;

FIG. 4C shows the use of an achromatic optic and calibration standard window;

FIG. 4D depicts an achromatic optic that incorporates a calibration standard that acts as a window;

FIG. 5 shows how a Raman calibration standard may be inserted within the collimated light path above the microscope objective; and

FIG. 6 is a partial cross section of a microscope objective with an integrated Raman calibration standard used in the analysis of multiple samples such as pharma tablets.

### DETAILED DESCRIPTION OF THE INVENTION

This invention is directed to the integration of a Raman calibration standard within an optical Raman sampling accessory which may include, without limitation, a Raman microscope, Raman immersion probe, Raman probe optic or Raman flow cell. Most existing commercial optical probes, microscope objectives and immersion probes utilizing laser light from the UV to the NIR region of the electromagnetic range will benefit from the invention.

The incorporation of a Raman calibration standard into the accessory generates a Raman spectral reference band superimposed onto the Raman spectra from a sample in real time as part of the measurement process. Unwanted wavenumber shifts observed in the Raman spectra due to laser wavelength and spectrograph drifting or instability can then be corrected by recentering the measured Raman spectra using the difference in wavenumber values between the measured value and the assigned value of the Raman calibration standard. For example, if the wavenumber position for calcium fluoride was measured at 323.2 wavenumbers, the Raman spectra would be recentered by −2.2 wavenumbers to the recognized and target value of 321.0 wavenumbers.

The wavenumber value for the position of the reference band of the Raman calibration standard is currently determined by curve fitting the imaged intensity distribution from a single collection fiber optic across only several pixels of the detector. Replacing the single collection fiber with a fiber bundle (e.g., 6 around 1), arranged in a linear array configuration at the entrance of the spectrograph, increases the number of imaged pixels/channels from the reference Raman spectral band across the detector.

Another approach is to use an achromatic cylindrical lens to image a line on to the entrance slit of the spectrograph, thereby increasing the number of imaged pixels/channels from the reference Raman spectral band across the detector. By averaging intensity values across multiple pixels/channels, this improves the curve fitting process and measurement precision. This bundled fiber collection or an achromatic cylindrical lens imaging approach may be used to achieve similar precision improvements as the proposed approach of slightly moving the diffraction grating between replicate measurements⁹. An additional benefit of using a bundled fiber or achromatic cylinder lens with a large diameter collection fiber is the stronger Raman signal associated with increasing the optical sampling depth of field within the sample.

By obtaining an extremely precise and repeatable wavenumber value for the position of the reference band, one may assign this as a global calibration correction wavenumber value. This value may then be applied to all instruments and future measurements allowing for calibration transfer between different instruments and probes at various global locations. This approach will eliminate any potential differences that might exist between the wavenumber values of individual Raman calibration standards.

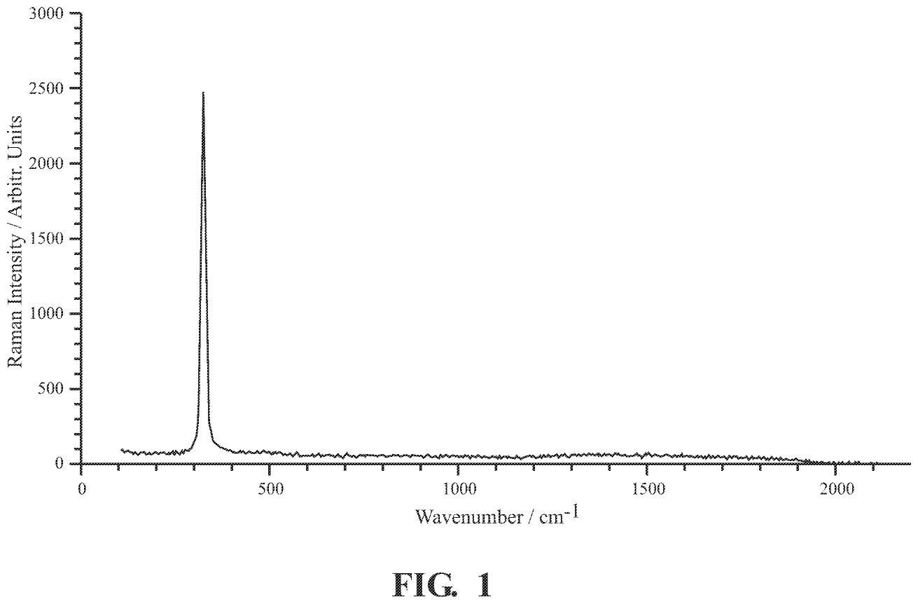

The preferred Raman calibration standard is selected based on the requirements of the application. For example, FIG. 1 outlines the Raman spectra of selected grade of Calcium Fluoride (CaF₂) with a clearly defined band at 321.0 wavenumbers. Position changes in the real time measurement can be used to recenter the Raman spectra to the required value of wavenumber precision. The 321.0 wavenumber band is outside of the 400-1800 wavenumber chemical fingerprint region and the 5-200 wavenumber Terahertz region, reducing the potential for overlapping of analytically important Raman bands from the sample with the calibration band. CaF₂ is well suited for microscopy and applications in life sciences such upstream and downstream fermentation and crystallization applications.

Materials with a single or multiple baseline-separated Raman bands are preferred as Raman calibration standards. As examples, calcium fluoride or diamond are preferred for red/NIR laser wavelengths, magnesium fluoride for blue laser wavelengths, and sapphire is well suited for high-temperature and high-pressure chemical applications and a silicon wafer as a reflector element in an immersion probe.

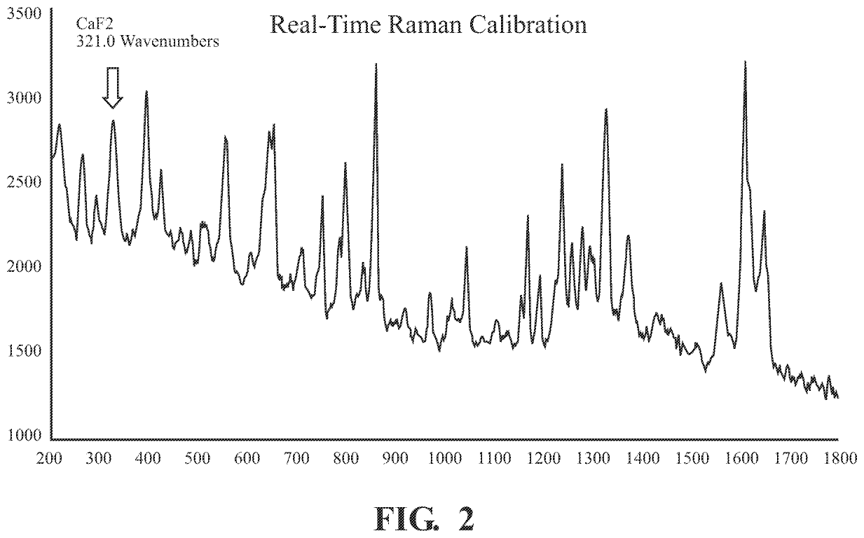

FIG. 2 shows the Raman spectra from a pharma tablet containing acetaminophen, aspirin, and caffeine with the 321.0 wavenumber band from a selected grade of calcium fluoride superimposed onto the Raman spectra of the pharma tablet.

For immersion probes using collimated laser with backscatter collection, the Raman calibration standard can function as the sealed window, combined with a reflector optic to operate as both the Raman calibration standard and the laser and Raman reflector, or optically coated with a reflector to act as both the Raman calibration standard and the laser and Raman reflector.

When the Raman calibration standard is part of the laser and Raman reflector, changes in the intensity of the Raman spectra from the standard can be used for monitoring the turbidity of the sample. Also, a thin sapphire window can be combined with a CaF₂ reference standard to provide protection for the CaF₂ reference standard against corrosive processes.

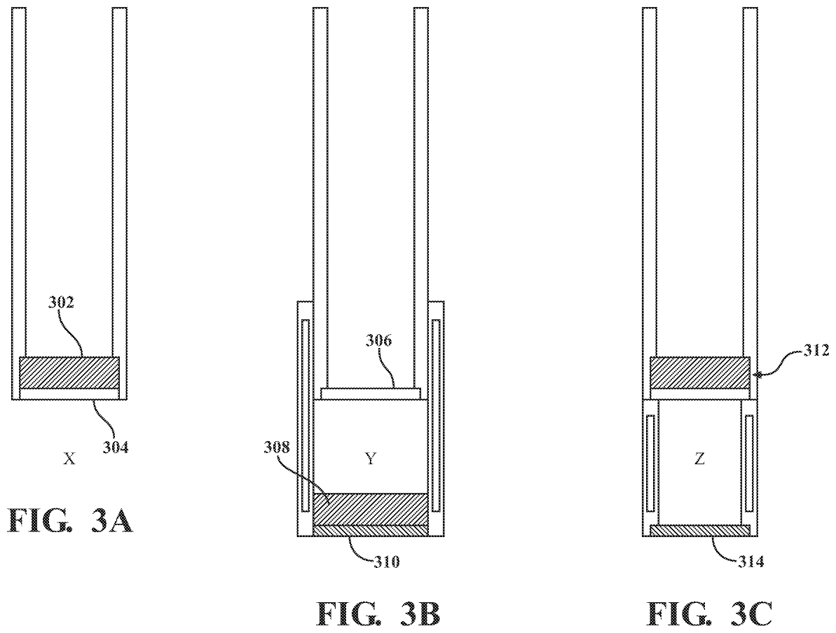

FIG. 3 shows the use of a Raman calibration standard located within the collimated space of several different immersion optic configurations. It is assumed that the sample volume is in regions X, Y and Z, respectively. In FIG. 3A, the calibration standard acts as a window at the distal end of the probe head. A single window of calibration material may be used or, alternatively, two components (i.e., CaF₂ 302 and sapphire 304) may be used. The spectrum of FIG. 2 was collected using a probe optic with the optical configuration shown in FIG. 3A. FIG. 3B shows the use of a sapphire window 306 in conjunction with a combined CaF₂ window 308 and retroreflector 310. FIG. 3C illustrates the use of a CaF2 window or combined CaF2/sapphire window 312 and retroreflector 314.

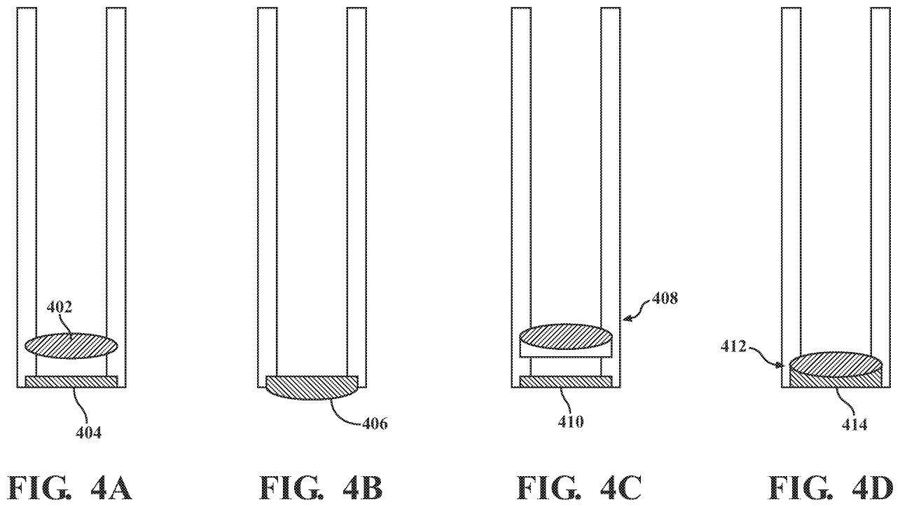

A Raman calibration standard may be integrated into most Raman immersion probes in accordance with the invention. For immersion probes using a single lens or achromatic lens design, the Raman calibration standard can function as the focusing optic, sealed window or as both a focusing optic and sealed window. FIG. 4A illustrates the use of a single lens optic 402 with a calibration standard lens or window 404. In FIG. 4B, the calibration standard 406 also acts as a lens and sealed window. FIG. 4C sows the use of an achromatic optic 408 and calibration standard window 410, and FIG. 4D depicts an achromatic optic 412 that incorporates a calibration standard that acts as a window 414.

For a Raman flow cell, the Raman calibration standard can function as the sealed window, or combined with a reflector optic to operate as both the Raman calibration standard and the laser and Raman reflector, or optically coated with a reflector to act as both the Raman calibration standard and the laser and Raman reflector.

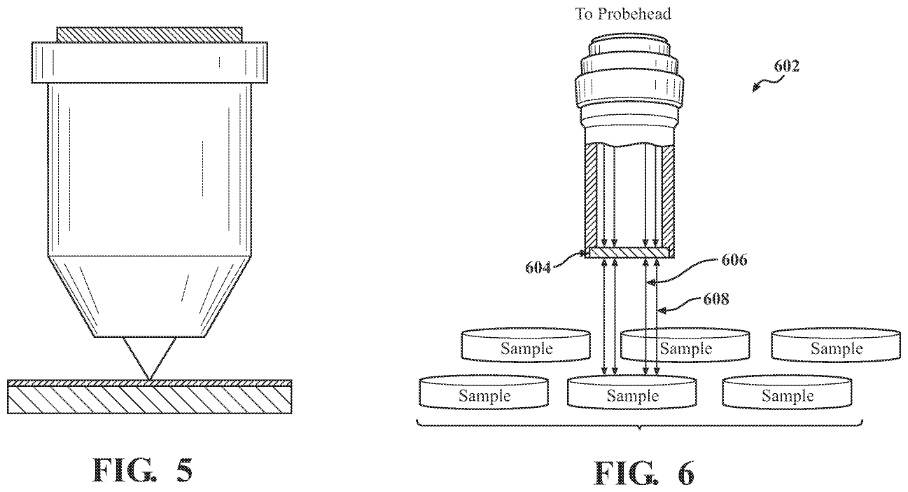

For a Raman microscope, the Raman calibration standard may be inserted within the collimated light path above the microscope objective as outlined in FIG. 5. FIG. 6 is a partial cross section of a microscope objective 602 with an integrated Raman calibration standard 604 used in the analysis of multiple sample such as pharma tablets. Lines 606, 608 show the counter-propagating excitation/collection beams to and from a particular sample.

### REFERENCES CITED

### U.S. Patent Documents

1. U.S. Pat. No. 5,652,653, 1997, Eastman Chemical, “On-line quantitative analysis of chemical compositions by Raman spectroscopy”
2. U.S. Pat. No. 6,141,095, 2000, Bruker Optical, “Apparatus for measuring and applying instrumentation correction to produce a standard Raman spectrum”.

### Other Publications

3. European Pharmacopoeia general chapter 2.2.48. (2016) Raman spectroscopy;
4. Standard Guide for Raman Shift Standards for Spectrometer Calibration Active Standard ASTM E1840-96(2014);
5. Tedesco, J. M.; Davis, K. L., “Calibration of dispersive Raman process analyzers”, SPIE vol. 3537, 1999;
6. Choquette J. S et al, “Relative Intensity Correction of Raman Spectrometers: NIST SRMs 2241 Through 2243 for 785 nm, 532 nm, and 488 nm/514.5 nm Excitation” National Institute of Standards and Technology;
7. Pelletier, M. J., “Effects of Temperature on Cyclohexane Raman Bands”, Applied. Spectroscopy. 1999, Volume 53;
8. Rolf W. Berg, Thomas Nørbygaard, “Wavenumber Calibration of CCD Detector Raman Spectrometers Controlled by a Sinus Arm Drive”, Applied Spectroscopy 2006, Volume 41;
9. Augustus W. Fountain III, *Thomas J. Vickers, and Charles K. “Factors that Affect the Accuracy of Raman Shift Measurements on Multichannel Spectrometers”, Applied Spectroscopy Volume 52, 1998.

1. A Raman analysis system with integrated wavelength calibration, comprising:
a sampling accessory used to deliver a collection beam from a laser-excited sample to a spectrograph for determining the Raman spectrum of the sample;
a calibration standard material incorporated into the sampling accessory, such that the spectrograph simultaneously receives a Raman spectrum of the sample and a Raman spectrum of the calibration standard; and
wherein the Raman spectrum of the calibration standard is used to calibrate the Raman spectrum of the sample.

2. The system of claim 1, wherein the Raman spectrum of the calibration standard is used to calibrate the Raman spectrum of the sample in real time.

3. The system of claim 1, wherein the sampling accessory is one of the following:
a Raman microscope objective,
a Raman immersion probe,
a Raman non-contact probe optic, and
a Raman flow cell.

4. The system of claim 1, wherein the calibration standard material is a selected grade of one or more of the following:
calcium fluoride,
sapphire,
diamond,
magnesium fluoride, and
silicon.

5. The system of claim 1, wherein:
the accessory is a microscope objective including a collimated light space; and
the calibration standard material is disposed in the collimated light space.

6. The system of claim 5, wherein:
the microscope objective has a distal end; and
the calibration standard material functions as a window at the distal end of the objective.

7. The system of claim 1, wherein the calibration standard material functions as a lens, window or both a lens and a window in the accessory.

8. The system of claim 1, wherein a plurality of calibration standard materials are incorporated into the accessory.

9. The system of claim 1, wherein the accessory includes a single lens or an achromatic focusing lens.

10. The system of claim 1, wherein the accessory includes a collimated light space.

11. The system of claim 1, wherein the calibration standard material functions as a reflector optic.

12. The system of claim 1, wherein the calibration standard material includes an optically coated reflector.

13. The system of claim 1, further including a fiber bundle for Raman signal collection to improve curve fitting and generate a more precise wavenumber value for the position of a reference Raman band generated by the calibration standard material.

14. The system of claim 1, wherein an achromatic cylindrical lens images a line from a larger diameter fiber optic onto an entrance slit of a spectrograph to improve curve fitting and generate a more precise wavenumber value for the position of a reference Raman band generated by the calibration standard material.

15. The system of claim 1, wherein a precise and repeatable wavenumber value for the position of a Raman reference band generated by the Raman calibration standard facilitates calibration correction and transfer between different instruments and probes at different locations.

16. The system of claim 1, wherein a Raman reference band generated by the Raman calibration standard is used to correct for changes in sample temperature.

17. The system of claim 1, wherein changes in the sample pressure can be measured in real time by tracking the difference between the pressure sensitive measured Raman spectra from the sample to the pressure insensitive measured wavenumber value of the Raman calibration standard.
